(19) United States
(12) Patent Application Publication
(10) Pub. No.: US 2021/0070625 A1
(43) Pub. Date: Mar. 11, 2021

(54) METHOD FOR IMPURITY CONTROL

(71) Applicant: ALCOA OF AUSTRALIA LIMITED, Booragoon (AU)

(72) Inventors: Shannon Dye, Booragoon (AU); Bronwyn Larner, Booragoon (AU); Anthony John McKinnon, Booragoon (AU)

(21) Appl. No.: 17/101,963

(22) Filed: Nov. 23, 2020

Related U.S. Application Data
(63) Continuation of application No. PCT/US2019/050479, filed on May 17, 2019.

(30) Foreign Application Priority Data
May 28, 2018 (AU) 2018901883

(51) Int. Cl. C01F 7/47; C01F 7/16; C01F 7/00

(52) U.S. Cl. CPC C01F 7/47; C01F 7/162; C01P 2002/22; C01F 7/164; C01F 7/005

(57) ABSTRACT

A method for controlling the concentration of impurities in Bayer liquors, the method comprising the steps of adding an oxide and/or a hydroxide of a metal other than aluminium to a Bayer liquor with a desired TA forming a layered double hydroxide; and incorporating at least one impurity in the layered double hydroxide, wherein the impurities are selected from the group comprising chloride, fluoride, sulfate and TOC.

### CROSS-REFERENCE TO RELATED APPLICATIONS

This application is a continuation of International Patent Application No. PCT/AU2019/050479, filed May 17, 2019, which claims priority to Australian Patent Application No. 2018901883, filed May 28, 2018, entitled “Method for Impurity Control”, each of which is incorporated herein by reference in its entirety.

### TECHNICAL FIELD

A method for controlling the concentration of impurities in Bayer liquors.

### BACKGROUND ART

The Bayer process is widely used for the production of alumina from alumina containing ores, such as bauxite. The process involves contacting alumina containing ores with recycled caustic aluminate solutions, at elevated temperatures, in a process commonly referred to as digestion. Solids are removed from the resulting slurry, and the solution cooled.

Aluminium hydroxide is added to the solution as seed to induce the precipitation of further aluminium hydroxide therefrom. The precipitated aluminium hydroxide is separated from the caustic aluminate solution, with a portion of the aluminium hydroxide being recycled to be used as seed and the remainder recovered as product. The remaining caustic aluminate solution is recycled for further digestion of alumina containing ore.

Bauxite ore generally contains organic and inorganic impurities, the amounts of which are specific to the bauxite source. As aluminium hydroxide is precipitated and bauxite dissolved, the concentrations of sodium hydroxide present in the process solution decrease, whilst concentrations of impurities increases, reducing the efficacy of the solution for digestion of further aluminium-containing ore. Accordingly, processes aimed at removing impurities from Bayer liquors have been developed.

Alumina refineries have developed numerous methods to address impurities in liquors and reduce their build up. Most impurity removal techniques are specific to the impurity in question, thereby complicating the entire circuit.

It is generally understood that high levels of organic carbon in Bayer process liquors reduces the alumina yield from that liquor. The most common presently employed method for removal of organics in the Bayer process is high temperature oxidation, in which a Bayer process “side stream” (a small percentage of the circulating load of a Bayer process plant) comprising a concentrated Bayer process liquor is mixed with alumina dust and passed to a kiln in which it is heated to temperatures in the order of 1000° C., thereby destroying the organics. The capital expenditure required for this process is expensive and the process may also require additional processes to mitigate potential environmental impacts.

Removal methods for some anions require the precipitation of the anion in question. For example, sulfate ions are precipitated as sodium decahydrate. Due to the large amount of water, the precipitate is difficult to separate from the liquor. Additionally, it is desirable to reintroduce the precipitate back into the circuit to reduce soda loss. However, this also results in the reintroduction of the impurity itself.

Layered Double Hydroxides (LDHs) are a family of lamellar minerals composed of positively charged brucite-like layers charge balanced with hydrated weakly bound anions located in the interlayer spaces. Most LDHs are binary systems where the charge on the layers is due to the substitution of some of the divalent cation sites within the lattice by mono- and/or tri-valent cations, giving a general formula of:

[MI1-xMIIIx(OH)2]q+(An−)x/n.yH2O or

[MIMIII2(OH)6](An−)1/n.yH2O

where M^{I}, M^{II} and M^{III} represents the mono-, di- and tri-valent metal cations within the layers respectively and A represents the interlayer anion(s). In the above formula, ‘A’ may be mono-, di- or multi-valent as long as the overall charge of the structure is neutral.

The most common naturally occurring LDHs are members of the Hydrotalcite (HTC) group, characterised by M²:M³+=3:1. The name-sake of this group, Hydrotalcite, is a Mg—Al structure and has the general formula of [Mg₃Al(OH)₆]₂.X.nH₂O, where ‘X’ represents the charge balancing anion(s).

Another group of LDHs referred to in this specification is the Hydrocalumite (HCM) group, which is characterised by M²⁺:M³⁺=Ca²⁺:Al³⁺=2:1. Hydrocalumite has the general formula of [Ca₂Al(OH)₆]ₓ.X.nH₂O, where ‘X’ is more specifically, one formula unit of a singly charged anion or half of a doubly charged anion. It will be appreciated that this is a general formula only and that X may be a combination of anions.

Throughout the specification, unless the context requires otherwise, the word “comprise” or variations such as “comprises” or “comprising”, will be understood to imply the inclusion of a stated integer or group of integers but not the exclusion of any other integer or group of integers.

Throughout the specification, unless the context requires otherwise, the word “solution” or variations such as “solutions”, will be understood to encompass slurries, suspensions and other mixtures containing undissolved solids.

The preceding discussion of the background to the invention is intended to facilitate an understanding of the present invention. However, it should be appreciated that the discussion is not an acknowledgement or admission that any of the material referred to was part of the common general knowledge in Australia or any other country as at the priority date.

### SUMMARY OF INVENTION

In accordance with the present invention, there is provided a method for controlling the concentration of impurities in Bayer liquors, the method comprising the steps of:
adding an oxide and/or a hydroxide of a metal other than aluminium to a Bayer liquor with a desired TA;
forming a layered double hydroxide; and
incorporating at least one impurity in said layered double hydroxide,
   wherein the impurities are selected from the group comprising chloride, fluoride, sulfate and TOC and the incorporation of chloride ion and fluoride ions increases with increasing Bayer liquor TA and the incorporation of sulfate ions and TOC decreases with increasing TA.

In accordance with the present invention, there is provided a method for controlling the concentration of impurities in Bayer liquors, the method comprising the steps of:
obtaining a liquor with a desired TA;
adding an oxide and/or a hydroxide of a metal other than aluminium to the Bayer liquor;
forming a layered double hydroxide; and
incorporating at least one impurity in said layered double hydroxide,
   wherein the impurities are selected from the group comprising chloride, fluoride, sulfate and TOC and wherein obtaining a liquor with a higher TA provides increased incorporation of chloride and/or fluoride than obtaining a liquor with a lower TA and wherein obtaining a liquor with a lower TA provides increased incorporation of sulfate and/or TOC than obtaining a liquor with a higher TA.

An important property of a Bayer liquor is its alkalinity, the total amount of alkali chemicals in the liquor. Most of the liquor alkalinity comes from the sodium hydroxide present, the other major contributor being sodium carbonate. The total alkalinity of a Bayer liquor is commonly described in terms of its TA which is measured in gL⁻¹ expressed as Na₂CO₃.

In the context of the present invention, the term TOC shall be understood to refer to the total dissolved organics in the Bayer liquor.

In the context of the present invention, the term incorporation shall be understood to include intercalation of impurities and adsorption of impurities.

Where the impurities are chloride and/or fluoride, the desired TA is preferably greater than 30 gL⁻¹. Where the impurities are sulfate and/or TOC, the desired TA is preferably less than 160 gL⁻¹.

In one form of the invention, the method comprises the further step of monitoring the concentration of at least one impurity in a Bayer circuit. Monitoring the concentration of at least one impurity in a Bayer circuit may comprise measuring the concentration of at least one impurity at any location within the Bayer circuit.

In one form of the invention, the method comprises the further step of measuring the concentration of at least one impurity in the Bayer liquor with a desired TA.

In one form of the invention, the method comprises the further step of:
measuring the concentration of at least one impurity in a Bayer liquor with a desired TA;
   prior to the step of:
adding an oxide and/or a hydroxide of a metal other than aluminium to a Bayer liquor with a desired TA.

In one form of the invention, the method comprises the further step of:
measuring the concentration of at least one impurity in a Bayer liquor with a desired TA;
   after the step of:
incorporating at least one impurity in said layered double hydroxide.

In one form of the invention, the method comprises the further step of:
measuring the concentration of at least one impurity in a Bayer liquor with a desired TA;
   both prior to and after the step of:
incorporating at least one impurity in said layered double hydroxide.

Advantageously, the concentration of at least one impurity in the Bayer liquor after the formation of the layered double hydroxide is less than the concentration of at least one impurity prior to the step of adding an oxide and/or a hydroxide of a metal other than aluminium to a Bayer liquor.

In one form of the invention, the method comprises the step of:
obtaining a Bayer liquor with a desired TA.

In one form of the invention, the method comprises the step of:
treating the Bayer liquor to provide a Bayer liquor with a desired TA.

Where the impurities are sulfate and/or TOC, the Bayer liquor may be treated prior to the step of adding an oxide and/or a hydroxide of a metal other than aluminium to the Bayer liquor, to reduce the TA of the Bayer liquor. Treatment of the Bayer liquor to reduce the TA may include dilution of the Bayer liquor with water or a second Bayer liquor.

Where the impurities are chloride and/or fluoride, the Bayer liquor may be treated prior to the step of adding an oxide and/or a hydroxide of a metal other than aluminium to the Bayer liquor, to increase the TA of the Bayer liquor. Treatment of the Bayer liquor to increase the TA may include addition or carbonate or hydroxide or the removal of water by methods including evaporation, reverse osmosis and membrane filtration or other forms of concentration.

In one form of the invention, the method comprises the further step of:
diluting the Bayer liquor
   prior to or concurrently with the step of:
adding an oxide and/or a hydroxide of a metal other than aluminium to a Bayer liquor with a desired TA;

Advantageously, the degree of incorporation of sulfate and TOC increases with liquor dilution.

In one form of the invention, the method comprises the further step of:
concentrating the Bayer liquor
   prior to or concurrently with the step of:
adding an oxide and/or a hydroxide of a metal other than aluminium to a Bayer liquor with a desired TA;

Advantageously, the degree of incorporation of chloride and fluoride increases with liquor dilution.

In one form of the invention, the TA is set to a predetermined value to maximise the incorporation of at least one target impurity.

In one form of the invention, the step of incorporating at least one impurity in said layered double hydroxide results in a reduction of the concentration of the at least one impurity of at least 10%. In one form of the invention, the step of incorporating at least one impurity in said layered double hydroxide results in a reduction of the concentration of the at least one impurity of at least 20%. In one form of the invention, the step of incorporating at least one impurity in said layered double hydroxide results in a reduction of the concentration of the at least one impurity of at least 30%. In one form of the invention, the step of incorporating at least one impurity in said layered double hydroxide results in a reduction of the concentration of the at least one impurity of at least 40%. In one form of the invention, the step of incorporating at least one impurity in said layered double hydroxide results in a reduction of the concentration of the at least one impurity of at least 50%. In one form of the invention, the step of incorporating at least one impurity in said layered double hydroxide results in a reduction of the concentration of the at least one impurity of at least 60%. In one form of the invention, the step of incorporating at least one impurity in said layered double hydroxide results in a reduction of the concentration of the at least one impurity of at least 70%. In one form of the invention, the step of incorporating at least one impurity in said layered double hydroxide results in a reduction of the concentration of the at least one impurity of at least 80%. In one form of the invention, the step of incorporating at least one impurity in said layered double hydroxide results in a reduction of the concentration of the at least one impurity of at least 90%.

The inventors have identified that when the TA of the Bayer liquor is below 160 gL⁻¹, it is possible to incorporate sulfate and/or TOC into layered double hydroxides thereby removing them from the Bayer liquor. The degree of incorporation increases as the TA is reduced. The present invention makes it possible to target and remove these impurities in Bayer liquors. Under certain conditions, it is possible to remove these impurities in preference to other impurities.

The inventors have identified that when the TA of the Bayer liquor is above 30 gL⁻¹, it is possible to incorporate chloride and/or fluoride into layered double hydroxides thereby removing them from the Bayer liquor. The degree of incorporation increases as the TA is increased. The present invention makes it possible to target and remove these impurities in Bayer liquors. Under certain conditions, it is possible to remove these impurities in preference to other impurities.

In one form of the invention, the method comprises the further step of:
adding at least one impurity to the Bayer liquor to provide an enriched Bayer liquor;
   prior to the step of:
forming a layered double hydroxide

Preferably, the step of:
adding at least one impurity to the Bayer liquor to provide an enriched Bayer liquor;
   is conducted prior to the step of:
adding an oxide and/or a hydroxide of a metal other than aluminium to the Bayer liquor with a desired TA;

Preferably, the at least one impurity added to the Bayer liquor is the same as the at least one impurity incorporated into the layered double hydroxide.

In one form of the invention, the method comprises the further step of:
separating the layered double hydroxide from the Bayer liquor to provide an impurity depleted liquor.

Preferably, the impurity depleted liquor is returned to the Bayer circuit.

In preferred forms of the invention, the formation of a layered double hydroxide under the conditions of the desired TA facilitates the incorporation of at least one impurity over at least one other impurity.

In the context of the present specification, the term facilitate shall not be limited to the incorporation of one impurity to the exclusion of others.

In preferred forms of the invention, the desired TA favours the incorporation of at least one impurity over at least one other impurity.

In the context of the present specification, the term favour shall not be limited to the incorporation of one impurity to the exclusion of others.

It will be appreciated that the step of incorporating at least one impurity in said layered double hydroxide will not necessarily mean that all of said impurity in the Bayer liquor is incorporated into said layered double hydroxide.

Where the impurities are sulfate and/or TOC, the Bayer liquor is preferably a washer overflow, diluted spent liquor, diluted green liquor or lakewater. Where the impurities are chloride and/or fluoride, the Bayer liquor is preferably a green liquor, a spent liquor or an increased TA liquor.

It will be appreciated that the oxide and/or a hydroxide of a metal other than aluminium will need to be one that can form a layered double hydroxide. In preferred forms of the invention, the metal other than aluminium is selected from the group comprising calcium and magnesium.

Preferably, the layered double hydroxide is hydrocalumite and/or hydrotalcite.

Preferably, the metal oxide other than aluminium is calcium hydroxide. Preferably, the calcium hydroxide is prepared by slaking calcium oxide. Preferably, the calcium oxide is slaked in lakewater. It will be appreciated that the addition of slaked lime to the Bayer liquor will decrease the TA of said liquor.

It will be appreciated that the lime charge will be dependent on the liquor type and concentration. While it is desirable to maximise the conversion to hydrocalumite, care should be taken not to deplete the liquor of alumina or carbonate.

Where the impurities are sulfate and/or TOC, the Bayer liquor in one form of the invention, has a TA less than 150 gL⁻¹. In an alternate form of the invention, the Bayer liquor has a TA less than 100 gL⁻¹. In an alternate form of the invention, the Bayer liquor has a TA less than 75 gL⁻¹. In an alternate form of the invention, the Bayer liquor has a TA between 50 and 100 gL⁻¹. It will be appreciated that the desired TA will be influenced by the choice of liquor. Where the liquor is a washer overflow, diluted spent liquor or diluted green liquor, the TA is preferably between 50 and 75 gL⁻¹. Where the liquor is a lakewater, the TA is preferably less than 50 gL⁻¹.

Given that the incorporation of sulfate and TOC are favoured by lower TA's, it is possible using the method of the present invention to target these impurities over others in Bayer liquors.

Where the impurities are chloride and/or fluoride, the Bayer liquor in one form of the invention, has a TA greater than 50 gL⁻¹. In an alternate form of the invention, the Bayer liquor has a TA greater than 70 gL⁻¹. In an alternate form of the invention, the Bayer liquor has a TA greater than 90 gL⁻¹. In an alternate form of the invention, the Bayer liquor has a TA greater than 100 gL⁻¹. In an alternate form of the invention, the Bayer liquor has a TA greater than 110 gL⁻¹. In an alternate form of the invention, the Bayer liquor has a TA greater than 130 gL⁻¹. In an alternate form of the invention, the Bayer liquor has a TA greater than 150 gL⁻¹. In an alternate form of the invention, the Bayer liquor has a TA greater than 160 gL⁻¹. In an alternate form of the invention, the Bayer liquor has a TA between 200 and 300 gL⁻¹. It will be appreciated that the desired TA will be influenced by the choice of liquor. Where the liquor is a washer overflow, diluted spent liquor or diluted green liquor, the TA is preferably between 50 and 75 gL⁻¹. Where the liquor is a lakewater, the TA is preferably less than 50 gL⁻¹.

Given that the incorporation of chloride and fluoride are favoured by higher TA's, it is possible using the method of the present invention to target these impurities over others in Bayer liquors.

Advantageously, the present invention allows a user to choose a TA that provides the best absolute or relative removal of at least one impurity over at least one other impurity.

Advantageously, the method of the present invention provides the vehicle to remove target impurities in Bayer liquors. To date, this has not been achievable as the relationship of impurity incorporation in layered double hydroxides with TA was not known. By controlling the TA of the Bayer liquor it is now possible to change the selectivities of layered double hydroxides for some impurities.

The method of the present invention may be used to prepare impurity-substituted layered double hydroxides.

### BRIEF DESCRIPTION OF THE DRAWINGS

Further features of the present invention are more fully described in the following description of several non-limiting embodiments thereof. This description is included solely for the purposes of exemplifying the present invention. It should not be understood as a restriction on the broad summary, disclosure or description of the invention as set out above. The description will be made with reference to the accompanying drawings in which:

FIG. 1 is a plot showing the effect of TA on sodium carbonate incorporation into hydrocalumite for the series of runs with 1^{st} refinery crystallizer feed shown in Table 1;

FIG. 2 is a plot showing the effect of TA on impurity incorporation into hydrocalumite for the series of runs with 1^{st} refinery crystallizer feed shown in Table 1;

FIG. 3 is a plot showing the effect of TA on impurity incorporation into hydrocalumite for the series of runs with 1^{st} refinery spent liquor feed shown in Table 2;

FIG. 4 is a plot showing the effect of TA on the amount of available impurity removed from a 1^{st} refinery spent liquor;

FIG. 5 is a plot showing the effect of TA on impurity incorporation into hydrocalumite for the series of runs with 1^{st} refinery green liquor feed; and

FIG. 6 is a plot showing the effect of TA on sodium carbonate incorporation into hydrocalumite for the series of runs with 1^{st} refinery green liquor feed.

### DESCRIPTION OF EMBODIMENTS

Throughout this specification, unless the context requires otherwise, the word “comprise” or variations such as “comprises” or “comprising”, will be understood to imply the inclusion of a stated integer or group of integers but not the exclusion of any other integer or group of integers.

Those skilled in the art will appreciate that the invention described herein is amenable to variations and modifications other than those specifically described. It is to be understood that the invention includes all such variations and modifications. The invention also includes all of the steps, features, compositions and compounds referred to or indicated in the specification, individually or collectively and any and all combinations or any two or more steps or features.

### Experimental

To further describe the invention, a series of experiments will now be described. It must be appreciated that the following description of the experiments is not to limit the generality of the above description of the invention.

Experiments were conducted in 3 L stainless steel water jacketed vessels with constant stirring at 1000 RPM. The temperature was maintained at 60° C. and the vessels contained baffles to ensure good mixing.

Liquor from an alumina refinery (hereinafter the 1^{st} Refinery) was used and slaked lime was sourced from a 2^{nd} Refinery. The slaked lime typically had a solids concentration of 250-260 gL⁻¹ with an available CaO content of approximately 56%. This lime had been produced by slaking in 2^{nd} Refinery lakewater. In some experiments, the lime concentration in the slaked lime slurry was increased to approximately 400 gL⁻¹ by allowing the lime solids to settle in the container and decanting off some of the lakewater.

The ratios of lime to liquor were kept constant and the TA was varied by changing the amount of distilled water added to the reaction mixture. The total reaction volume was approximately 2 L.

### Example 1—Crystalliser Feed

The effect of reaction TA was first investigated using a 1^{st} Refinery crystalliser feed liquor as the source liquor. A crystalliser feed liquor is a spent liquor that has undergone evaporation to increase its TA (typically by 10%). The TA of the crystalliser feed liquor was 279.4 gL⁻¹. The reaction mixtures examined ranged from 80-230 gL⁻¹ TA. The highest reaction TA was from a reaction mixture with undiluted feed liquor, with subsequent mixtures having more water added to the mixture to lower the reaction TA. The reaction mixture compositions are shown in Table 1. Note that the reactor TA for Run No 1 is approximately 50 gL⁻¹ lower than the feed liquor TA due to the dilution effect of the lakewater contained within the lime slurry. The lime concentration was ratioed to the liquor volume and thus the lime concentration in the reactor dropped with each run. The ‘CaO Conc in Feed’ column shows the amount of CaO present relative to the amount of feed liquor and this is seen to remain constant. In this experiment a concentrated lime slurry was used which had a solids concentration of 400 gL⁻¹ and an effective CaO concentration of 224 gL⁻¹.

TABLE 1
Effect of TA reaction mixtures for the experiments
carried out with crystalliser feed liquor.

| | | Lime | | Lime | CaO | |
|---|---|---|---|---|---|---|
| | Liquor | Slurry | Water | Conc in | Conc in | Reactor |
| Run | Volume | Mass | Volume | Reactor | Feed | TA |
| No. | (L) | (kg) | (L) | (gL⁻¹) | (gL⁻¹) | (gL⁻¹) |
| 1 | 1.60 | 0.71 | 0.0 | 122.9 | 99 | 228.8 |
| 2 | 1.40 | 0.63 | 0.26 | 109.4 | 100 | 199.0 |
| 3 | 1.20 | 0.54 | 0.53 | 94.6 | 100 | 168.9 |
| 4 | 1.00 | 0.45 | 0.80 | 79.5 | 100 | 139.4 |
| 5 | 0.80 | 0.36 | 1.07 | 64.1 | 100 | 110.4 |
| 6 | 0.60 | 0.27 | 1.35 | 48.3 | 100 | 81.6 |

FIG. 1 displays the amount of sodium carbonate removed per tonne of hydrocalumite produced for the series of runs in Table 1. It is seen that the amount of sodium carbonate incorporated into the hydrocalumite is independent of TA. This is a typical result for all of the liquors examined in this work. There is a small amount of variation in sodium carbonate incorporated between different liquor sources but with a constant liquor source there is no variation in sodium carbonate incorporation.

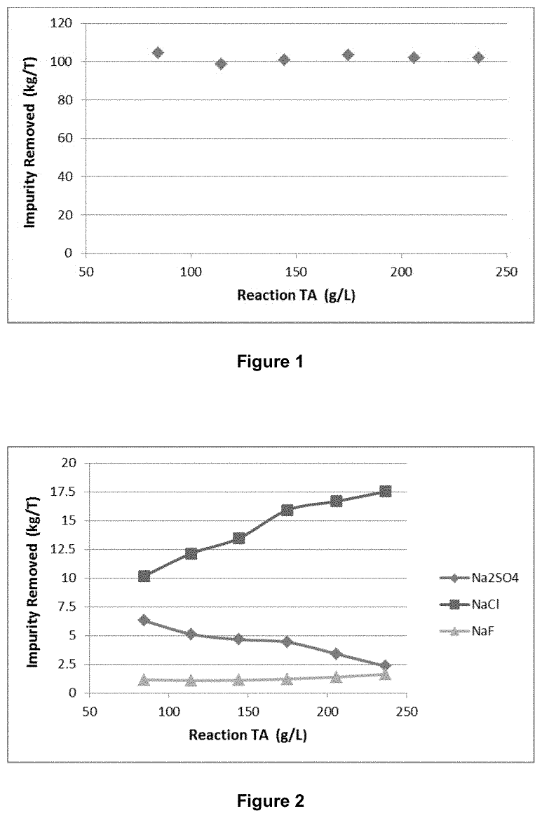

FIG. 2 shows the amount of several impurities incorporated into the hydrocalumite for the series of runs contained in Table 1. This result shows that the level of each impurity incorporated depended on reaction TA. The amount of sodium sulfate incorporation decreased with increasing reaction TA, whereas the level of sodium chloride incorporation increased with reaction TA. The concentration of sodium sulfate in the crystalliser feed was 23.5 gL⁻¹ and the sodium chloride concentration was 16.7 gL⁻¹.

These variations of impurity incorporation with TA were unexpected, given that the ratio of lime to feed liquor was constant in each of the experiments and thus the amount of hydrocalumite produced is ratioed to the amount of feed liquor. Thus, one would expect that the level of impurity removal would be constant.

### Example 2—Spent Liquor

Spent liquor from the 1^{st} Refinery was investigated with non-concentrated slaked lime from the 2^{nd} Refinery. The slaked lime had a solids concentration of 257 g/L and an effective CaO concentration of 141 gL⁻¹. The reaction mixture compositions for the runs with the spent liquor are shown in Table 2. The reaction TA varied from 30-176 gL⁻¹. The highest TA examined in this case is significantly lower than with the crystalliser feed run, because the start liquor TA is lower at 262 gL⁻¹ and because the lime slurry used is not concentrated thus there is more dilution.

TABLE 2
Effect of TA reaction mixtures for the experiments
carried out with a spent feed liquor.

| | | Lime | | Lime | CaO | |
|---|---|---|---|---|---|---|
| | Liquor | Slurry | Water | Conc in | Conc | Reactor |
| Run | Volume | Volume | Volume | Reactor | in Feed | TA |
| No. | (L) | (L) | (L) | (gL⁻¹) | (gL⁻¹) | (gL⁻¹) |
| 1 | 1.30 | 0.97 | 0.0 | 110.1 | 106 | 176.0 |
| 2 | 1.15 | 0.86 | 0.24 | 98.4 | 106 | 155.2 |
| 3 | 1.00 | 0.74 | 0.48 | 85.9 | 105 | 134.8 |
| 4 | 0.85 | 0.63 | 0.73 | 73.4 | 105 | 113.6 |
| 5 | 0.70 | 0.52 | 0.98 | 60.3 | 104 | 92.9 |
| 6 | 0.55 | 0.40 | 1.24 | 47.0 | 103 | 72.0 |
| 7 | 0.40 | 0.29 | 1.52 | 33.3 | 101 | 51.3 |
| 8 | 0.23 | 0.17 | 1.72 | 20.3 | 103 | 30.3 |

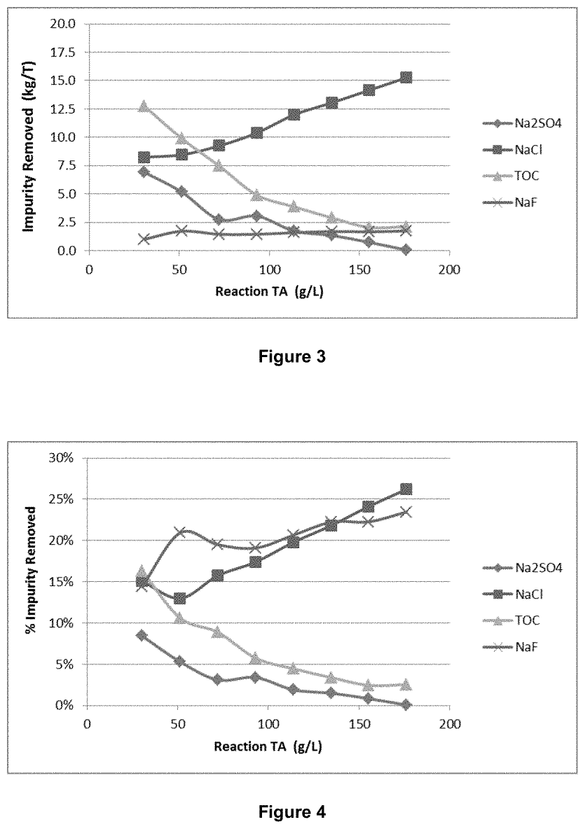

FIG. 3 shows the amount of several impurities incorporated into the hydrocalumite for the runs contained in Table 2, this time also measuring TOC incorporation. The data for the 1^{st} Refinery spent liquor shows a similar trend in impurity incorporation as that seen for the 1^{st} Refinery crystallizer feed liquor. There is a trend to increasing sodium fluoride incorporation with increasing TA, as well as a significant increase in sodium chloride incorporation with increasing TA. As previously, sodium sulfate incorporation decreases with increasing TA and TOC is seen to have a similar trend. Sodium carbonate incorporation remains relatively constant over this TA range, with an average incorporation of 110 kgT⁻¹ of hydrocalumite production.

The liquor composition for the 1^{st} Refinery spent liquor is displayed in Table 3 along with a 1^{st} Refinery green liquor for comparison.

TABLE 3
Liquor composition for 1^{st} refinery spent liquor along with
the composition of a green liquor from the 1^{st} refinery.

| | TA | TC | Al₂O₃ | Na₂SO₄ | NaCl | TOC | NaF |
|---|---|---|---|---|---|---|---|
| Liquor | (gL⁻¹) | (gL⁻¹) | (gL⁻¹) | (gL⁻¹) | (gL⁻¹) | (gL⁻¹) | (gL⁻¹) |
| 1^{st} Refinery | 262 | 215 | 95 | 20.6 | 15.3 | 22.0 | 1.5 |
| Spent | | | | | | | |
| Liquor | | | | | | | |
| 1^{st} Refinery | 247 | 200 | 144 | 22.0 | 14.8 | 22.6 | 1.4 |
| Green | | | | | | | |
| Liquor | | | | | | | |

FIG. 4 shows the relative amount of each impurity removed as a function of TA. The same trends in relative impurity removal are still demonstrated, i.e. TOC and sulfate removal decrease with TA, whereas chloride and fluoride removal increase with TA.

### Example 3—Green Liquor

A green liquor from the 1^{st} Refinery with the composition displayed in Table 3 was used in this trial. The mixture compositions for the runs are shown in Table 4 with the slaked lime having a solids concentration of 257 gL⁻¹ and an effective CaO concentration of 141 gL⁻¹.

TABLE 4
Effect of TA reaction mixtures for experiments
carried out with green liquor.

| | | Lime | | Lime | CaO |
|---|---|---|---|---|---|
| | Liquor | Slurry | Water | Conc in | Conc in |
| Run | Volume | Volume | Volume | Reactor | Feed |
| No. | (L) | (L) | (L) | (gL⁻¹) | (gL⁻¹) |
| 1 | 1.30 | 0.96 | 0.0 | 108.9 | 104 |
| 2 | 1.15 | 0.85 | 0.24 | 97.2 | 104 |
| 3 | 1.00 | 0.74 | 0.48 | 85.3 | 104 |
| 4 | 0.85 | 0.62 | 0.73 | 72.4 | 103 |
| 5 | 0.70 | 0.51 | 0.98 | 59.4 | 102 |
| 6 | 0.55 | 0.39 | 1.24 | 46.3 | 101 |
| 7 | 0.40 | 0.28 | 1.52 | 33.0 | 100 |
| 8 | 0.23 | 0.17 | 1.72 | 20.2 | 102 |

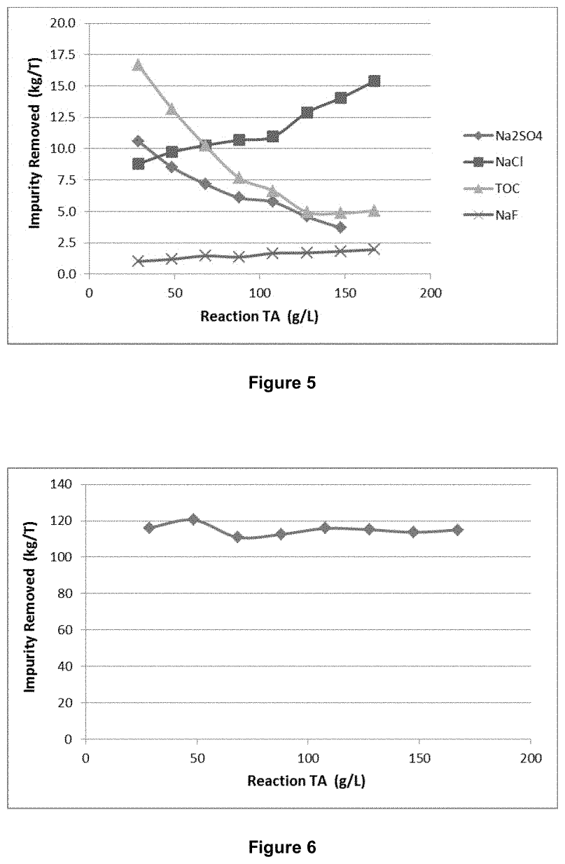

The effect of TA on the impurity incorporation into the hydrocalumite in green liquor is shown in FIGS. 5 and 6. FIG. 5 shows that TOC and sodium sulfate incorporation decreases with increasing TA whereas the degree of sodium chloride incorporation increases with TA. Sodium fluoride incorporation increases with TA, but the effect is not as pronounced due to the low overall level of incorporation (due probably to the low fluoride concentration in the feed liquor). The amount of sodium carbonate removed per tonne of hydrocalumite produced is displayed in FIG. 6. Again there is little variation in the amount of sodium carbonate incorporated within the hydrocalumite and there is no trend in the amount of carbonate incorporated as TA varies. Overall the impurity incorporation trends for the green liquor match those of the spent liquors demonstrating that impurity incorporation is independent of feed liquor source.

### Example 4—Washer Liquor

Finally the liquor from a washer was used as a liquor source. The washer liquor was from the last washer at the 2^{nd} Refinery and was used both neat and diluted 50% with water to compare the effect on impurity incorporation. Each run was undertaken in triplicate and the reaction mixtures are given in Table 5.

TABLE 5
Effect of TA reaction mixtures for experiments
carried out with a last washer liquor.

| | | Lime | | Lime | CaO | |
|---|---|---|---|---|---|---|
| | Liquor | Slurry | Water | Conc in | Conc in | Reactor |
| Liquor | Volume | Volume | Volume | Reactor | Feed | TA |
| type | (L) | (L) | (L) | (gL⁻1) | (gL⁻¹) | (gL⁻¹) |
| Neat | 1.70 | 0.48 | 0.0 | 56.5 | 40 | 48.3 |
| Dilute | 0.90 | 0.26 | 0.9 | 32.6 | 41 | 26.4 |

The incorporation results are given in Table 6 both for each mixture and an average of the runs for each liquor type. The results show that the levels of a particular impurity incorporated is reasonably reproducible for a given liquor type. Apart from sodium carbonate, the trends in impurity incorporation with TA are the same for the last washer liquor as the other liquors examined. TOC and sodium sulfate incorporation decrease with increasing TA, whereas the degree of sodium chloride and sodium fluoride incorporation increases with TA.

TABLE 6
The amount of impurity incorporation in hydrocalumite
produced from both a neat last washer liquor
and from one diluted 50% with water.

| | Reactor | | | | | |
|---|---|---|---|---|---|---|
| Liquor | TA | Na₂CO₃ | Na₂SO₄ | NaCl | TOC | NaF |
| type | (gL⁻¹) | (kgT⁻¹) | (kgT⁻¹) | (kgT⁻¹) | (kgT⁻¹) | (kgT⁻¹) |
| Neat | 48.3 | 94.4 | 11.4 | 5.2 | 9.8 | 1.3 |
| Neat | 48.3 | 93.9 | 11.3 | 5.3 | 9.7 | 1.7 |
| Neat | 48.3 | 92.4 | 10.0 | 4.8 | 9.1 | 1.4 |
| Average | 48.3 | 93.6 | 10.9 | 5.1 | 9.5 | 1.5 |
| Neat | | | | | | |
| Dilute | 26.4 | 101.8 | 14.5 | 5.0 | 10.7 | 1.2 |
| Dilute | 26.4 | 103.1 | 14.4 | 4.6 | 10.9 | 1.0 |
| Dilute | 26.4 | 102.9 | 13.4 | 4.4 | 10.5 | 1.0 |
| Average | 26.4 | 102.6 | 14.1 | 4.7 | 10.7 | 1.1 |
| Dilute | | | | | | |

1. A method for controlling the concentration of impurities in Bayer liquors, the method comprising the steps of:
adding an oxide and/or a hydroxide of a metal other than aluminium to a Bayer liquor with a desired TA;
forming a layered double hydroxide; and
incorporating at least one impurity in the layered double hydroxide,
wherein the impurities are selected from the group comprising chloride, fluoride, sulfate and TOC;
wherein the incorporation of chloride ion and fluoride ions increases with increasing Bayer liquor TA; and
wherein the incorporation of sulfate ions and TOC decreases with increasing TA.

2. The A method of claim 1, wherein the impurities are chloride and/or fluoride and the desired TA is greater than 30 gL⁻¹.

3. The method of claim 1, wherein the impurities are sulfate and/or TOC and the desired TA is less than 160 gL⁻¹.

4. The method of claim 1, comprising: monitoring the concentration of at least one impurity in a Bayer circuit.

5. The method of claim 1, comprising: measuring the concentration of at least one impurity in the Bayer liquor with a desired TA.

6. The method of claim 1, comprising:
measuring the concentration of at least one impurity in the Bayer liquor with a desired TA;
prior to the step of:
adding the oxide and/or the hydroxide of a metal other than aluminium to the Bayer liquor with a desired TA.

7. The method of claim 1, comprising:
measuring the concentration of at least one impurity in a Bayer liquor with a desired TA;
after the step of:
incorporating the at least one impurity in the layered double hydroxide.

8. The method of claim 1, wherein the concentration of the at least one impurity in the Bayer liquor after the formation of the layered double hydroxide is less than the concentration of the at least one impurity prior to the step of adding the oxide and/or the hydroxide of a metal other than aluminium to the Bayer liquor.

9. The method of claim 1, comprising:
obtaining the Bayer liquor with the desired TA.

10. The method of claim 1, comprising:
treating the Bayer liquor to achieve the desired TA.

11. The method of claim 10, wherein the impurities are sulfate and/or TOC and the treating step occurs prior to the step of adding the oxide and/or the hydroxide of a metal other than aluminium to the Bayer liquor, to reduce the TA of the Bayer liquor.

12. The method of 10, wherein the impurities are chloride and/or fluoride and the treating step occurs prior to the step of adding the oxide and/or the hydroxide of a metal other than aluminium to the Bayer liquor, to increase the TA of the Bayer liquor.

13. The method of claim 1, wherein the step of incorporating at least one impurity in the layered double hydroxide results in a reduction of the concentration of the at least one impurity of at least 10%.

14. The method of claim 1 comprising:
adding at least one impurity to the Bayer liquor to provide an enriched Bayer liquor;
prior to the step of:
forming the layered double hydroxide

15. The method of claim 1, wherein the impurities are sulfate and/or TOC and wherein the Bayer liquor is washer overflow, diluted spent liquor, diluted green liquor or lakewater.

16. The method of claim 1, wherein the impurities are chloride and/or fluoride and the Bayer liquor is a green liquor, a spent liquor or an increased TA liquor.

17. The method of claim 1, wherein the metal other than aluminium is selected from the group comprising calcium and magnesium.

18. The method of claim 1, wherein the layered double hydroxide is hydrocalumite and/or hydrotalcite.

19. The method of claim 1, wherein the impurities are sulfate and/or TOC and the Bayer liquor has a TA less than 150 gL⁻¹.

20. The method of claim 1, wherein the impurities are chloride and/or fluoride and the Bayer liquor has a TA greater than 50 gL⁻¹.
